(19) United States
(12) Patent Application Publication
(10) Pub. No.: US 2014/0152600 A1
(43) Pub. Date: Jun. 5, 2014

(54) TOUCH DISPLAY DEVICE FOR VEHICLE AND DISPLAY METHOD APPLIED FOR THE SAME

(71) Applicant: ASUSTeK COMPUTER INC., Taipei (TW)

(72) Inventors: Yen-Chun LEE, TAIPEI (TW); Chin-Yi WU, TAIPEI (TW); Yen-Hwa CHEN, TAIPEI (TW); Chun-Han CHENG, TAIPEI (TW); Fang-Ping LIN, TAIPEI (TW)

(73) Assignee: ASUSTeK COMPUTER INC., Taipei (TW)

(21) Appl. No.: 14/092,859

(22) Filed: Nov. 27, 2013

Related U.S. Application Data
(60) Provisional application No. 61/733,431, filed on Dec. 5, 2012.

(30) Foreign Application Priority Data
Jun. 28, 2013 (TW) 102123317

(51) Int. Cl. G06F 3/041

(52) U.S. Cl. CPC G06F 3/041
USPC 345/173

(57) ABSTRACT

A touch display device fixed on a vehicle and including a display portion is provided. The display portion includes an information display area, a first interface and a second interface. The first interface and the second interface can be displayed at two sides of the display portion simultaneously. The first interface is near a driver seat and the second interface is near a non-driver seat. Moreover, a display method applied to a touch display device for a vehicle is also provided herein.

### CROSS-REFERENCE To RELATED APPLICATION

This application claims the priority benefit of U.S. provisional application Ser. No. 61/733,431, filed on Dec. 5, 2012 and Taiwan application serial No. 102123317, filed on Jun. 28, 2013. The entirety of the above-mentioned patent applications are hereby incorporated by reference herein and made a part of specification.

### BACKGROUND OF THE INVENTION

1. Field of the Invention

The invention relates to a touch display device for a vehicle.

2. Description of the Related Art

Instead of conventional keyboards and cursor control devices, most users uses touch screens or touch panels for operating electronic devices, and users can control image contents and functions of program displayed on the electronic devices or operating systems of the electronic devices more intuitively, and thus the use can contact and control hardware devices more conveniently.

However, in a conventional electronic device, only a single constant user interface is configured to or displayed on a touch screen, and it cannot meet operating requirements of different users. For example, only one user interface and a related menu are provided at a touch screen of an electronic device for a user operating, however, the menu content cannot be suitable for different users, and it cannot always meet the operating habits of different users.

### BRIEF SUMMARY OF THE INVENTION

A touch display device for a vehicle and a display method applied for the same are provided to meet the operating habits of different users. The touch display device for a vehicle includes a display portion. The display portion includes an information display area, a first interface and a second interface. The first interface includes a first operating menu and the second interface includes a second operating menu. The first interface and the second interface can be displayed at two sides of the display portion simultaneously. The first interface is near a driver seat and the second interface is near a non-driver seat.

A display method applied to a touch display device for a vehicle is provided. The touch display device for a vehicle includes a display portion. The display portion includes an information area, a first interface and a second interface. The display method includes: displaying the first interface at a side of the display portion which is near the driver seat or displaying the second interface at another side of the display portion which is near a non-driver seat; wherein the first interface includes a first operating menu and the second interface includes a second menu.

### BRIEF DESCRIPTION OF THE DRAWINGS

FIG. 1 is a schematic diagram showing a touch display device for a vehicle in a first embodiment;

FIG. 2 is a schematic diagram showing a touch display device in FIG under different operating situations in an embodiment;

FIG. 3 is a schematic diagram showing a touch interface and menus of a touch display device for a vehicle in a second embodiment;

FIG. 4 to FIG. 7 are schematic diagrams showing a touch interface and menus of a touch display device for a vehicle in a third embodiment; and

FIG. 8 is a flow chart showing a display method applied to a touch display device for a vehicle in an embodiment.

### DETAILED DESCRIPTION OF THE EMBODIMENTS

The invention is illustrated with embodiments and accompanying figures, however, the embodiments are not used for limiting the scope of the invention, and description of operations is not used for limiting the execution sequence, any structure or device recombined by components having an equal effect device is covered by the invention. Additionally, the figures are only for the purpose of illustration and not drawn in accordance with the original size. In order to facilitate understanding, the same symbols denote the same components.

Terms used in the specification and claims, unless otherwise stated, have common meanings as used in the art, in the contents of the invention and in the special contents. The terms “including”, “comprising”, “contain”, “has” are open-ended words, which means including but not limited to

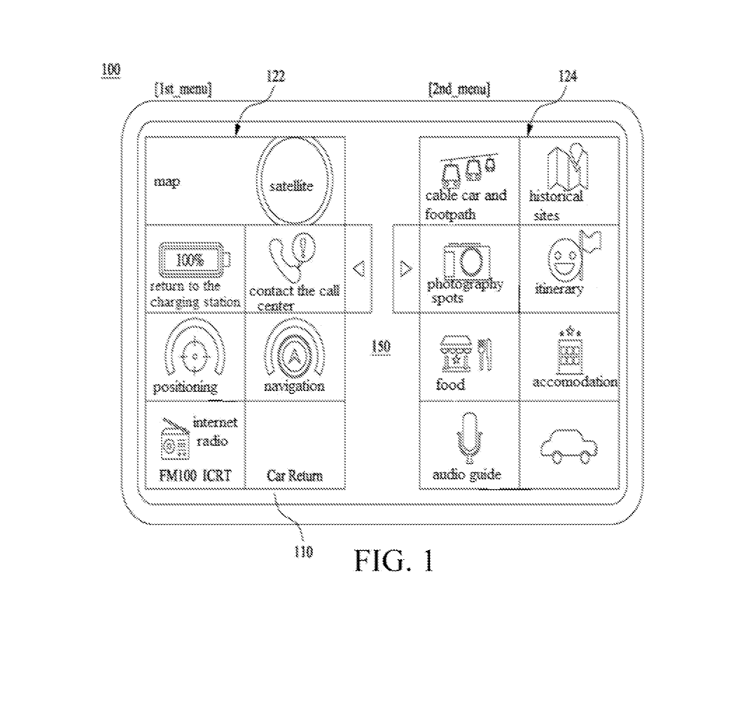

FIG. 1 is a schematic diagram showing a touch display device for a vehicle in a first embodiment. Please refer to FIG. 1, the touch display device 100 for a vehicle is configured for a vehicle and includes a display portion 110. The display portion 110 includes an information display area 150 (such as a map image, an information image) and selectively displays a first interface 122 and a second interface 124. The first interface 122 includes a first operating menu 1st_menu and the second interface 124 includes a second operating menu 2nd_menu. In some embodiments, the information display area 150 is controlled via the first interface 122 and the second interface 124.

The first interface 122 and the second interface 124 are displayed at different sides of the display portion 110. For example, the first interface 122 and the first operating menu 1st_menu are displayed at a side of the display portion 110 which is near a driver seat, and the second interface 124 and the second operating menu 2nd_menu are displayed at the other side of the display portion 110 which is near a non-driver seat, which is not limited herein. In other words, the first interface 122 and the second interface 124 can be displayed at opposite sides or adjacent sides, which is not limited herein.

Thus, when the touch display device 100 for a vehicle is applied at a particular situation (such as the vehicle including a driver and a co-driver), the touch display device 100 for a vehicle displays a corresponding touch interface for different users operating according to different requirements. The touch display device 100 for a vehicle also may be configured with a corresponding sensing unit or a corresponding hardware, so as to detect positions of different users, and it displays the touch interface and the menus corresponding to the positions of users automatically (that is, the arrangements of menus are automatically set). The touch interface and the arrangement of the menus also may he determined according to the usual position of the user in the situation.

In some embodiments, the first operating menu and the second operating menu is customized. In more detail, the first operating menu 1st_menu of the first interface 122 is determined according to a driver, and the second operating menu 2nd_menu of the second interface 124 is determined according to a passenger, and the first operating menu 1st_menu may he different or partly different from the second operating menu 2nd_menu.

For example, options of the first operating menu 1st_menu include “map”, “return to the charging station”, “contact the call center”, “navigation”, “positioning”, “car return” and “internet radio” which much relates to a driver. Options of the second operating menu 2nd_menu include “historical sites”, “cable car and footpath”, “photography spots”, “itinerary”, “food”, “accommodation” and “audio guide” which much relates to a passenger, which is not limited herein. Options of the first operating menu 1st_menu and the second operating 2nd_menu can he determined according to practical requirements or different situations, which is not limited herein.

The first operating menu 1st_menu and the second operating menu 2nd_menu may he a main menu or a submenu, respectively. In other words, different submenus of the first operating menu 1st_menu and the second operating menu 2nd_menu can be displayed by clicking options of the first operating menu 1st_menu and the second operating menu 2nd_menu.

Styles and shapes of the first interface 122, the first operating menu 1st_menu, the second interface 124 and the second operating menu 2nd_menu is not limited to these shown in FIG. 1, they can be designed according to practical requirements.

In some embodiments, the first interface 122 and the second interface 124 are selectively overlapped to display on the information display area 150. For example, when the touch display device 100 is operated, the display portion 110 displays a corresponding information area 150 via a presetting or a touch control, and the first interface 122 is selectively displayed on the display portion 110 and overlapped to display on the information display area 150 by clicking, and the second interface 124 is also selectively displayed on the display portion 110 and overlapped to the information display area 150 by clicking.

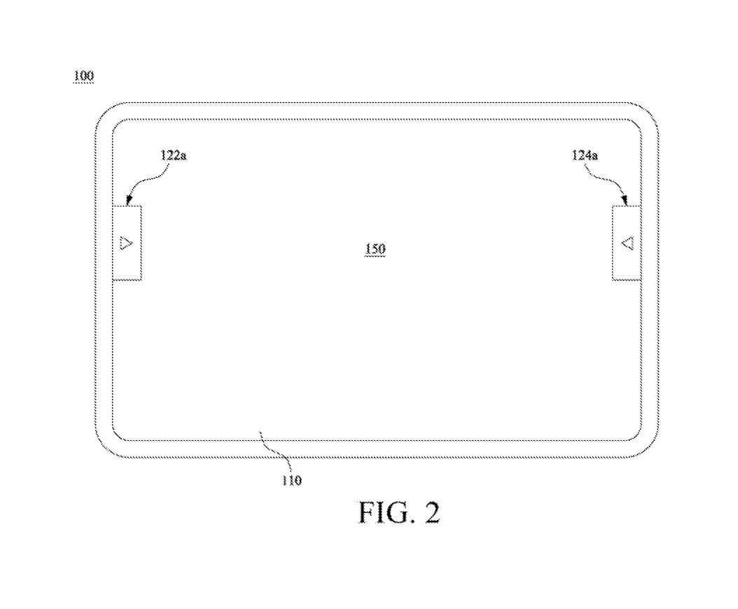

In some embodiments, the first interface 122 and the second interface 124 may he hidden at sides of the display portion 110, or at least one of the first interface 122 and the second interface 124 is displayed on the display portion 110 by demand. For example, FIG. 2 is a schematic diagram showing a touch display device in FIG. 1 under different operating situations, the first interface 122 and the second interface 124 are preset to be hidden at sides of the display portion 110, and only corresponding arrow symbols 122a and 124a are displayed. Different users can click the arrow symbol 122a or 124a according to practical operating requirements to make the first interface 122 and the second interface 124 displayed on the display portion 110 as shown in FIG. 1.

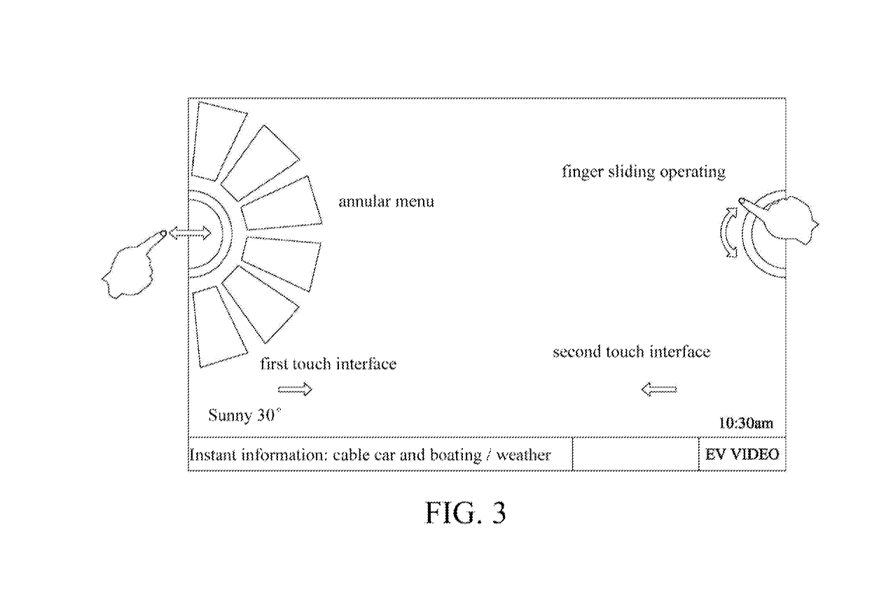

The first interface 122 and the second interface 124 can be hidden or displayed on the display portion 110 in different ways. The user can also touch and click a required touch interface and the menus in different ways. FIG. 3 is a schematic diagram showing a touch interface and menus of another touch display device in an embodiment. Please refer to FIG. 3, the touch interface is displayed in annular, and a finger sliding mode of the operating way may he as FIG. 3 shown, which is not limited herein.

Then, please refer to FIG. 1, when the first operating menu 1st_menu of the first interface 122 is operated, the priority of the first operating menu 1st_menu is higher than that of the second operating menu 2nd_menu of the second interface operated at the same time. Therefore, an operating image of a higher priority shows on the information display area 150. More specifically, operating images corresponding to the options of the first operating menu 1st_menu may be all or partly prior to the operating images corresponding to the options of the second operating menu 2nd_menu to be displayed on the display portion 110.

For example, when a user clicks an “itinerary” option of the second operating menu 2nd_menu and the information display area 150 displays an image corresponding to the “itinerary” option, and then another user clicks a “navigation” option of the first operating menu 1st_menu, the image corresponding to the “navigation” option, which is prior to the image corresponding to the “itinerary” option, is displayed on the display portion 110. Similarly, when the user clicks a “navigation” option of the first operating menu 1st_menu and the information display area 150 displays an image corresponding to the “navigation” option, when another user continues to click an “itinerary” option of the second operating menu 2nd_menu, operating menu, the image corresponding to the “navigation” option which is still prior to the image corresponding to the “itinerary” option is displayed on the display portion 110, that is the information display area 150 is still not immediately switched to the image corresponding to the “itinerary” option.

The operating images corresponding to the options of the first operating menu 1st_menu may be all or partly prior to the operating images corresponding to the options of the second operating menu 2nd_menu to be displayed on the display portion 110 according to practical requirements (such as in consideration of urgency and importance).

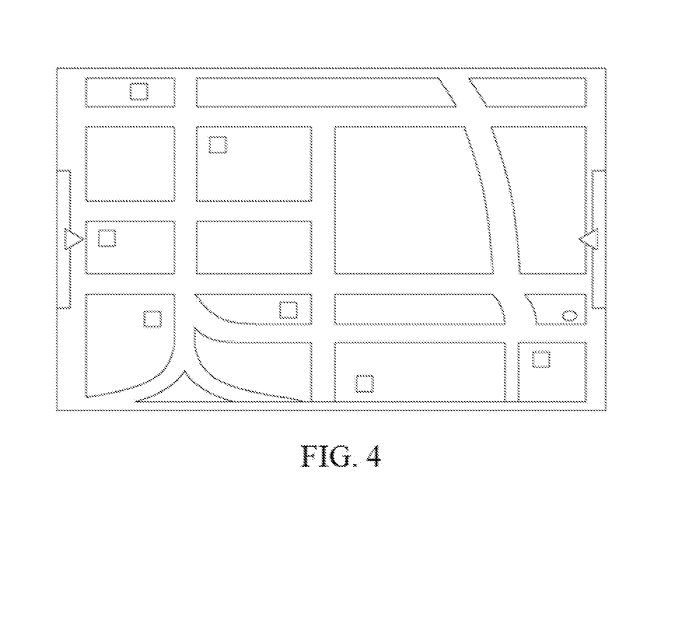

FIG. 4 to FIG. 7 are schematic diagrams showing a touch interface and menus of a touch display device for a vehicle in a third embodiment. Please refer to FIG. 4, the screen displays a corresponding operating image via presetting or touching control. For example, the screen displays a map image via presetting or touching control, and the touch interface is displayed by touching and clicking the arrow symbols at the left and right sides of the screen, which is not limited herein.

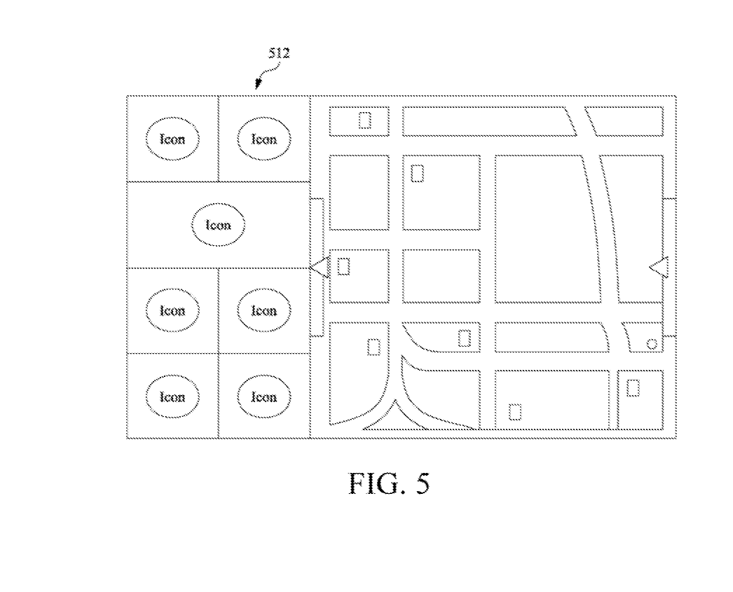

Please refer to FIG. 5, when the user clicks the arrow symbol at the left side of the screen, the first interface 512 at the left side is displayed on the screen, and the map image automatically zooms out to a corresponding screen size to make the first interface 512 and the map image displayed on the screen simultaneously, and both of them are completely displayed for different users operating.

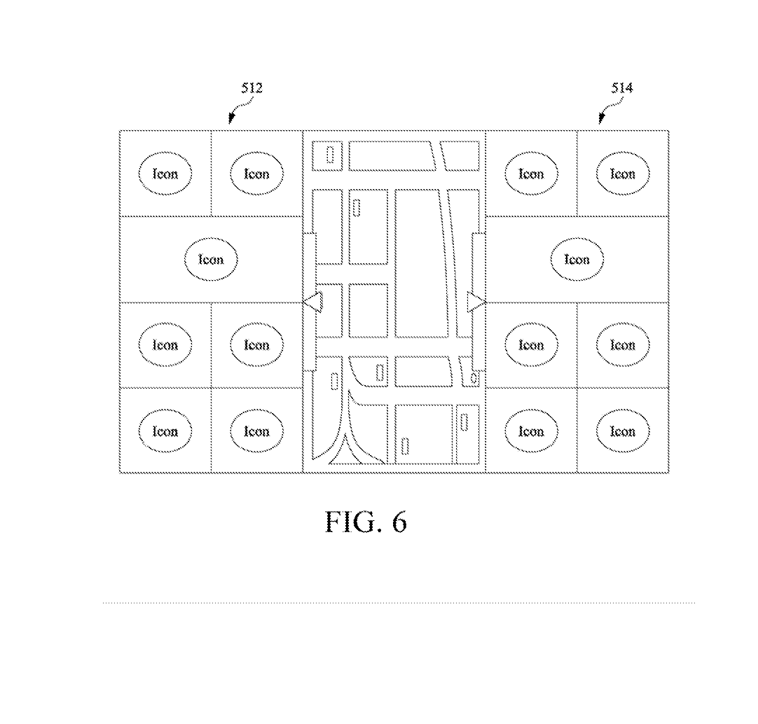

Then, please refer to FIG. 6, when the user further clicks the arrow symbol the right side of the screen, the second interface 514 at the right side is displayed on the screen, and the map image automatically zooms out to a corresponding screen size again to make the first interface 512, the second interface 514 and the map image displayed on the screen, and all of them are completely displayed for different users operating.

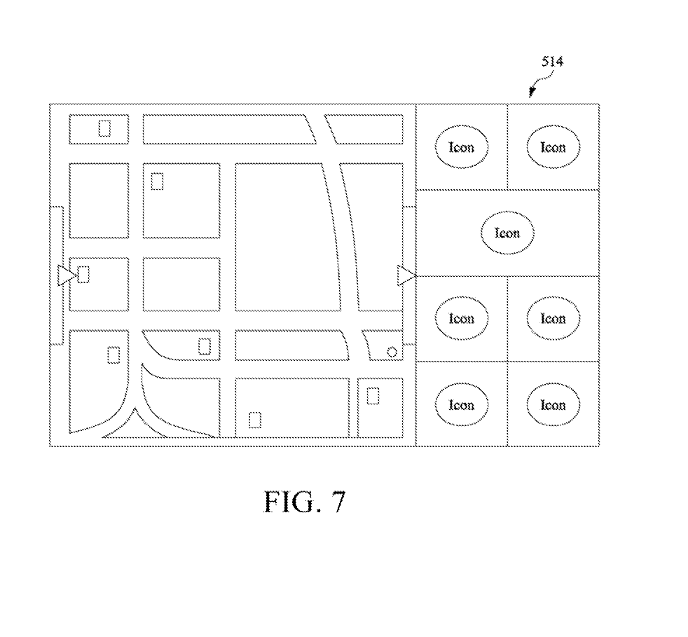

Similarly, please refer to FIG. 7, when the user further clicks the arrow symbol at the left side of the screen, the first interface 512 at the left side is hidden in a side of the screen, and the map image automatically zooms in to a corresponding screen size, the second interface 514 and the map image are displayed on the screen simultaneously, and both of them are completely displayed for different users operating.

Furthermore, when the user further clicks the arrow symbol at the right side of the screen, the second interface 514 at the right side is hidden at another side of the screen, and the map image automatically zooms in again to a screen size as shown in FIG. 4.

As stated above, the information area 150 can zoom in or zoom out according to whether the touch interface is displayed or not to make the operating image more flexible and meet operating requirements of different users.

A display method applied to a touch display device is provided. The display method includes the following steps and can be applied to the touch display device 100, which is not limited herein. For the convenience of description, the following display method is illustrated with the touch display device 100 as an example.

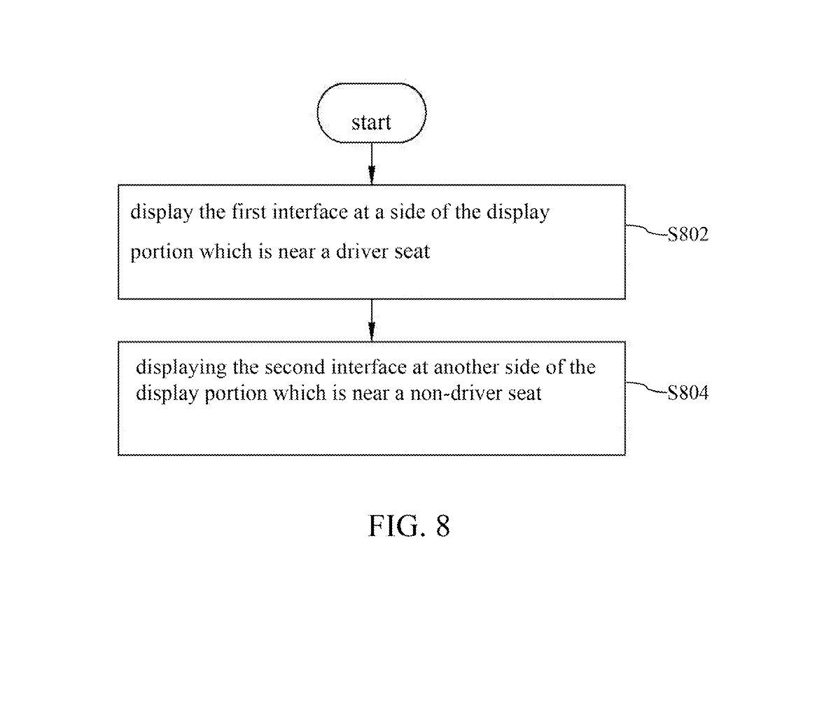

FIG. 8 is a flow chart showing a display method applied to a touch display device. Please refer to FIG. 1 and FIG. 8. First, the first interface 122 is selectively displayed at a side of the display portion 110 which is near a driver seat (step S802). Then, the second interface 124 is selectively displayed at another side of the display portion 110 which is near a non-driver seat (step S804).

In some embodiments, the display method further includes: controlling the information display area 150 via the first interface 122 and the second interface 124.

In some embodiments, the first operating menu 1st_menu of the first interface 122 is determined according to a driver, and the second operating menu 2nd_menu of the second interface 124 is determined according to a passenger, and the first operating 1st_menu may be different from or partly the same as the second operating menu 2nd_menu.

For example, options of the first operating menu 1st_menu include “map”, “return to the charging station”, “contact the call center”, “navigation”, “positioning”, “car return” and “internet radio” which much relates to a driver. Options of the second operating menu 2nd_menu include “historical sites”, “cable car and footpath”, “photography spots”, “itinerary”, “food”, “accommodation” and “audio guide” which much relates to a passenger.

In some embodiments, the display method further includes: selectively hiding or displaying the first interface 122 and the second interface 124 at sides of the display portion 110, respectively. The detail can refer to above embodiments, which is omitted herein.

In some embodiments, the display method further includes: selectively overlappingly displaying the first interface 122 and the second interface 124 overlapped at the information display area 150, respectively. The detail can refer to above embodiments, which is omitted herein.

In some embodiments, the display method further includes: zooming out or zooming in the information display area 150 according to whether the first interface 122 or the second interface 124 is displayed or not. The detail can refer to above embodiments, which is omitted herein.

In some embodiments, the display method further includes: displaying the operating images corresponding to the options of the first operating menu 1st_menu which are all or partly prior to the operating images corresponding to the options of the second operating menu 2nd_menu on the display portion 110. In other words, when the first operating menu 1st_menu of the first interface 122 is operated, a priority of the first operating menu 1st_menu is higher than that of the second operating menu 2nd_menu of the second interface 124 operated at the same time, and information display area 150 displays an operating image of a higher priority.

The sequence of steps mentioned in the embodiment, unless specially illustrated, can be adjusted according to practical requirements, even all or part of the steps can be executed at the same time.

According to the touch display device and the display method in embodiments, a corresponding touch interface can be displayed for different users according to different requirements in a particular situation (such as a vehicle with a driver and a co-driver), and different touch interfaces can meet requirements of different users. Moreover, a corresponding touch interface is designed for multiple users to operate the touch interface together without any conflict, which is more flexible on the operation.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A touch display device for a vehicle, comprising:
a display portion including an information display area, a first interface and a second interface;
wherein the first interface includes a first operating menu, and the second interface includes a second operating menu, the first interface is displayed at a side of the display portion which is near a driver seat, and the second interface is displayed at a second display portion which is near a non-driver seat.

2. The touch display device for a vehicle according to claim 1, wherein the first operating menu and the second operating menu are different or partly different.

3. The touch display device for a vehicle according to claim 1, wherein the first interface and the second interface are selectively hidden or displayed at two sides of the display portion.

4. The touch display device for a vehicle according to claim 1, wherein the information display area is controlled via the first interface or the second interface.

5. The touch display device for a vehicle according to claim 1, wherein when the first operating menu and the second operating menu are operated at the same time, a priority of the first operating menu is higher than the priority of the second operating menu, and the information display area displays an operating image of a higher priority.

6. The touch display device for a vehicle according to claim 1, wherein the first interface and the second interface are selectively overlapped to display on the information display area.

7. The touch display device for a vehicle according to claim 1, wherein the information display area zooms in or zooms out according to whether the first interface and the second interface are displayed or not.

8. A display method applied to a touch display device for a vehicle, wherein the touch display device includes a display portion, the display portion includes an information display area, a first interface and a second interface, the method comprising:
displaying the first interface at a side of the display portion which is near a drive seat or displaying the second interface at another side of the display portion which is near a non-driver seat, wherein the first interface includes a first operating menu and the second interface includes a second operating menu.

9. The display method according to claim 8, wherein the first operating menu is different or partly different from the second operating menu:

10. The display method according to claim 8, further comprising:
selectively hiding or displaying the first interface and the second interface at two sides of the display portion, respectively.

11. The display method according to claim 8, further comprising:
controlling the information display area via the first interface and the second interface.

12. The display method according to claim 8, wherein when the first operating menu and the second operating menu are operated at the same time a priority of the first operating menu is higher than the priority of the second operating menu, and the information display area displays an operating image of a higher priority.

13. The display method according to claim 8, further comprising:
selectively displaying the first interface and the second interface overlapped at the information display area.

14. The display method according to claim 8, further comprising:
zooming in or zooming out the information display area according to whether the first interface and the second interface are displayed or not.
